(19) United States
(12) Patent Application Publication
(10) Pub. No.: US 2024/0340999 A1
(43) Pub. Date: Oct. 10, 2024

(54) DISCONTINUOUS RECEPTION TIMER CONFIGURATIONS FOR JOINT CHANNEL ESTIMATION

(71) Applicant: QUALCOMM Incorporated, San Diego, CA (US)

(72) Inventors: Linhai HE, San Diego, CA (US); Hung Dinh LY, San Diego, CA (US); Ruiming ZHENG, Beijing (CN)

(21) Appl. No.: 18/579,740

(22) PCT Filed: Oct. 1, 2021
(86) PCT No.: PCT/CN2021/122482

§ 371 Date: Jan. 16, 2024

(51) Int. Cl. H04W 76/28; H04L 25/02; H04L 47/283; H04W 72/0446

(52) U.S. Cl. CPC H04W 76/28; H04L 25/0202; H04L 47/283; H04W 72/0446

(57) ABSTRACT

Various aspects of the present disclosure generally relate to wireless communication. In some aspects, a user equipment (UE) may transmit at least one physical uplink shared channel (PUSCH) repetition of a plurality of PUSCH repetitions associated with a joint channel estimation configuration that indicates at least one time domain window for transmission of the plurality of PUSCH repetitions. The UE may activate, after an end of the at least one time domain window, a discontinuous reception round trip time (RTT) timer based at least in part on the transmission of the at least one PUSCH repetition. Numerous other aspects are described.

### FIELD OF THE DISCLOSURE

Aspects of the present disclosure generally relate to wireless communication and to techniques and apparatuses for discontinuous reception timer configurations for joint channel estimation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, an apparatus for wireless communication at a user equipment (UE) includes a memory and one or more processors coupled to the memory. The one or more processors may be configured to transmit at least one physical uplink shared channel (PUSCH) repetition of a plurality of PUSCH repetitions associated with a joint channel estimation configuration that indicates at least one time domain window for transmission of the plurality of PUSCH repetitions. The one or more processors may be further configured to activate, after an end of the at least one time domain window, a discontinuous reception round trip time (RTT) timer based at least in part on the transmission of the at least one PUSCH repetition.

In some aspects, an apparatus for wireless communication at a base station includes a memory and one or more processors coupled to the memory. The one or more processors may be configured to transmit a joint channel estimation configuration that indicates at least one time domain window for transmission of a plurality of PUSCH repetitions. The one or more processors may be further configured to transmit a discontinuous reception configuration that indicates that a UE is to activate a discontinuous reception RTT timer based at least in part on an occurrence of an end of the at least one time domain window.

In some aspects, a method of wireless communication performed by a UE includes transmitting at least one PUSCH repetition of a plurality of PUSCH repetitions associated with a joint channel estimation configuration that indicates at least one time domain window for transmission of the plurality of PUSCH repetitions. The method also may include activating, after an end of the at least one time domain window, a discontinuous reception RTT timer based at least in part on the transmission of the at least one PUSCH repetition.

In some aspects, a method of wireless communication performed by a base station includes transmitting a joint channel estimation configuration that indicates at least one time domain window for transmission of a plurality of PUSCH repetitions. The method also may include transmitting a discontinuous reception configuration that indicates that a UE is to activate a discontinuous reception RTT timer based at least in part on an occurrence of an end of the at least one time domain window.

In some aspects, a non-transitory computer-readable medium storing a set of instructions for wireless communication includes one or more instructions that, when executed by one or more processors of a UE, cause the UE to transmit at least one PUSCH repetition of a plurality of PUSCH repetitions associated with a joint channel estimation configuration that indicates at least one time domain window for transmission of the plurality of PUSCH repetitions. The one or more instructions also may cause the UE to activate, after an end of the at least one time domain window, a discontinuous reception RTT timer based at least in part on the transmission of the at least one PUSCH repetition.

In some aspects, a non-transitory computer-readable medium storing a set of instructions for wireless communication includes one or more instructions that, when executed by one or more processors of a base station, cause the base station to transmit a joint channel estimation configuration that indicates at least one time domain window for transmission of a plurality of PUSCH repetitions. The one or more instructions also may cause the base station to transmit a discontinuous reception configuration that indicates that a UE is to activate a discontinuous reception RTT timer based at least in part on an occurrence of an end of the at least one time domain window.

In some aspects, an apparatus for wireless communication includes means for transmitting at least one PUSCH repetition of a plurality of PUSCH repetitions associated with a joint channel estimation configuration that indicates at least one time domain window for transmission of the plurality of PUSCH repetitions. The apparatus also may include means for activating, after an end of the at least one time domain window, a discontinuous reception RTT timer based at least in part on the transmission of the at least one PUSCH repetition.

In some aspects, an apparatus for wireless communication includes means for transmitting a joint channel estimation configuration that indicates at least one time domain window for transmission of a plurality of PUSCH repetitions. The apparatus also may include means for transmitting a discontinuous reception configuration that indicates that a UE is to activate a discontinuous reception RTT timer based at least in part on an occurrence of an end of the at least one time domain window.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example associated with discontinuous reception (DRX) timer configurations for joint channel estimation, in accordance with the present disclosure.

FIGS. 4 and 5 are diagrams illustrating example processes associated with DRX timer configurations for joint channel estimation, in accordance with the present disclosure.

FIGS. 6 and 7 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

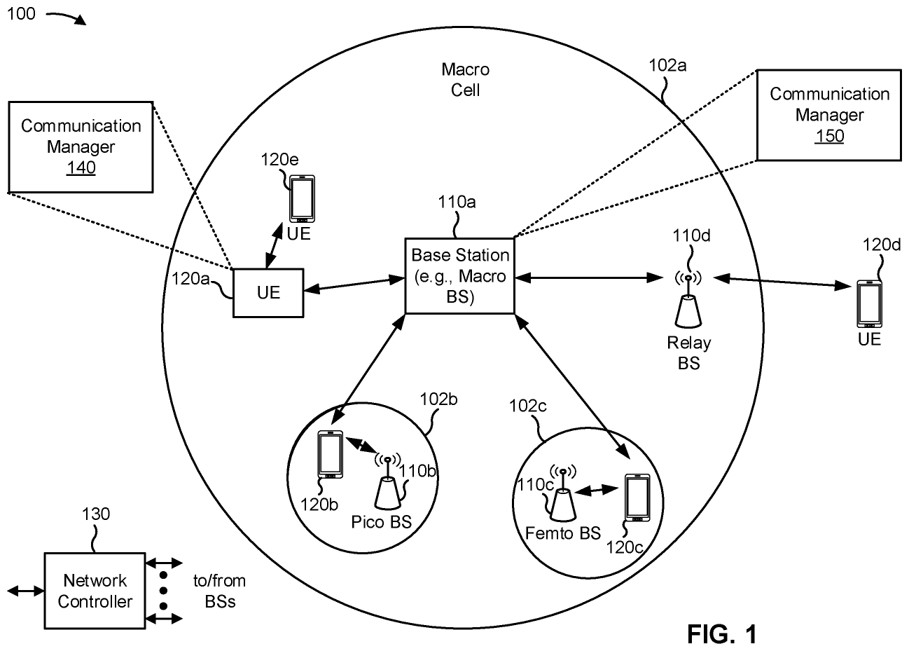

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit at least one physical uplink shared channel (PUSCH) repetition of a plurality of PUSCH repetitions associated with a joint channel estimation configuration that indicates at least one time domain window for transmission of the plurality of PUSCH repetitions; and activate, after an end of the at least one time domain window, a discontinuous reception (DRX) round trip time (RTT) timer based at least in part on the transmission of the at least one PUSCH repetition. Additionally, or alternatively, the communication manager 140 may perform one or more other operations described herein.

In some aspects, the base station 110 may include a communication manager 150. As described in more detail elsewhere herein, the communication manager 150 may transmit a joint channel estimation configuration that indicates at least one time domain window for transmission of a plurality of PUSCH repetitions; and transmit a discontinuous reception configuration that indicates that a UE is to activate a DRX RTT timer based at least in part on an occurrence of an end of the at least one time domain window. Additionally, or alternatively, the communication manager 150 may perform one or more other operations described herein.

As indicated above, FIG. 1 is provided as an example. Other examples may differ from what is described with regard to FIG. 1.

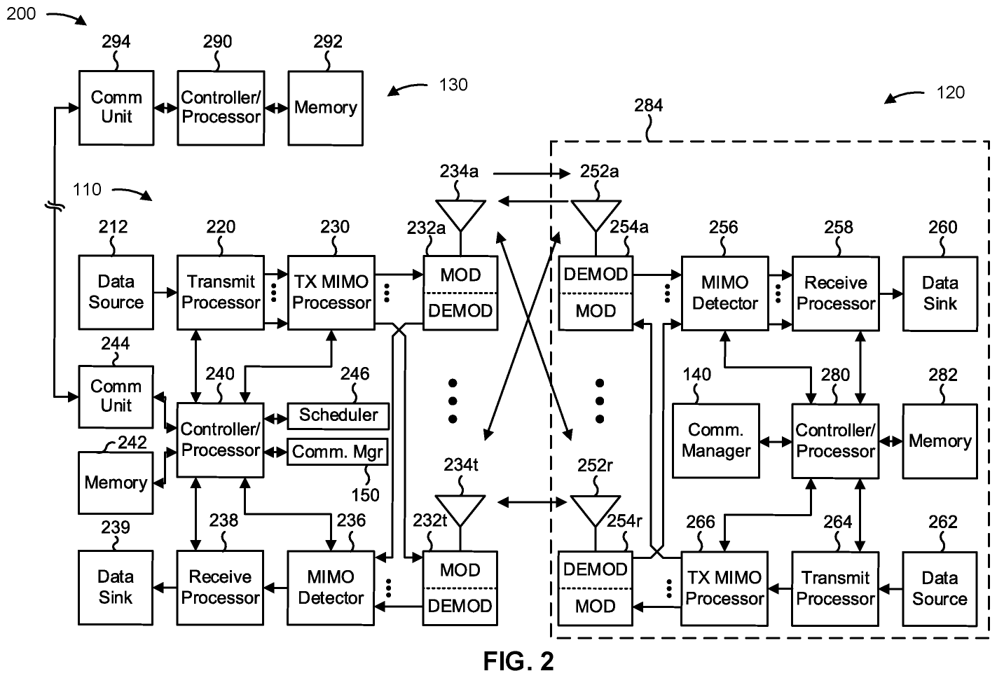

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

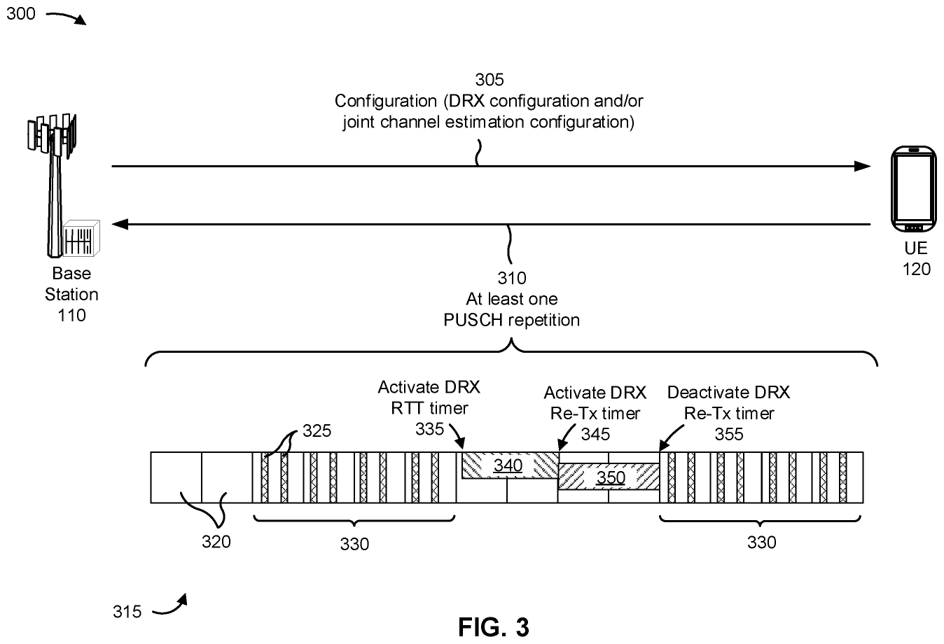

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-7).

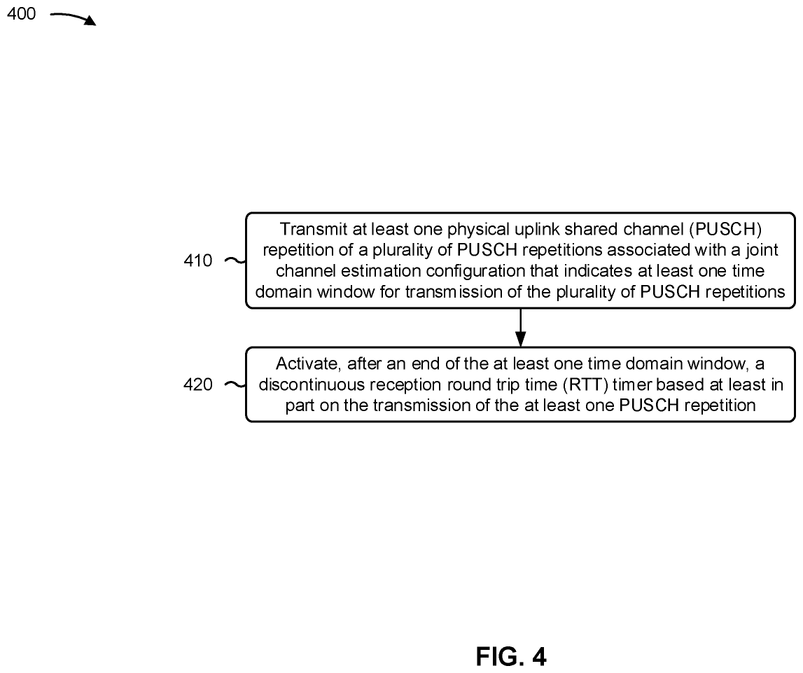

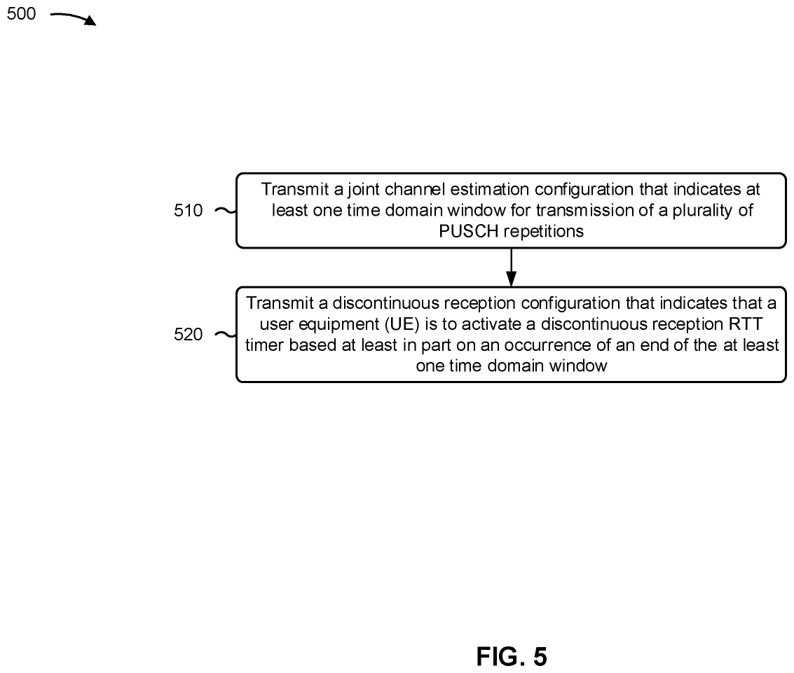

The controller/processor 240 of the base station 110, the controller/processor 280 of the UE 120, and/or any other component(s) of FIG. 2 may perform one or more techniques associated with discontinuous reception (DRX) timer configurations for joint channel estimation, as described in more detail elsewhere herein. For example, the controller/processor 240 of the base station 110, the controller/processor 280 of the UE 120, and/or any other component(s) of FIG. 2 may perform or direct operations of, for example, process 400 of FIG. 4, process 500 of FIG. 5, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 400 of FIG. 4, process 500 of FIG. 5, and/or other processes as described herein. In some examples, executing instructions may include running the instructions, converting the instructions, compiling the instructions, and/or interpreting the instructions, among other examples.

In some aspects, the UE includes means for transmitting at least one PUSCH repetition of a plurality of PUSCH repetitions associated with a joint channel estimation configuration that indicates at least one time domain window for transmission of the plurality of PUSCH repetitions; and/or means for activating, after an end of the at least one time domain window, a DRX RTT timer based at least in part on the transmission of the at least one PUSCH repetition. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting a joint channel estimation configuration that indicates at least one time domain window for transmission of a plurality of PUSCH repetitions; and/or means for transmitting a discontinuous reception configuration that indicates that a UE is to activate a DRX RTT timer based at least in part on an occurrence of an end of the at least one time domain window. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

In some cases, a UE may transmit one or more demodulation reference signals (DMRSs) to a base station. A DMRS may include a reference signal that is generated from a base sequence, such as a Zadoff-Chu sequence or a Gold sequence. A DMRS may carry information used to estimate a radio channel for demodulation of an associated physical channel. The physical channel may include, for example, a physical downlink control channel (PDCCH), a physical downlink shared channel (PDSCH), a physical uplink control channel (PUCCH), and/or a physical uplink shared channel (PUSCH), among other examples. The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. DMRSs are used for both downlink communications and uplink communications.

The base station may perform one or more measurements of a DMRS to estimate a physical channel on which one or more communications are transmitted from the UE. In this way, for example, the base station and/or the UE may determine whether a channel quality of the physical channel satisfies one or more channel quality thresholds, and may use the results from the one or more measurements to facilitate demodulation of the communications transmitted on the physical channel.

In some cases, a UE may associate or bundle a plurality of time-domain resources for purposes of joint channel estimation (which may be referred to as uplink DMRS bundling and/or DMRS bundling), in which case the base station may assume that the same precoder is used across the plurality of time-domain resources and that DMRS transmissions across the plurality of time-domain resources may be coherently filtered to increase the accuracy of the channel estimation.

In some cases, whether a UE supports PUSCH DMRS bundling and/or physical uplink control channel (PUCCH) DMRS bundling can depend on one or more UE capabilities for phase continuity maintenance. In some cases, the ability of a UE to maintain phase continuity can depend on whether the PUSCH transmission (or PUCCH transmission) is contiguous, a length of a gap between transmissions, and/or a configuration of the gap between transmissions, among other examples.

In some cases, a UE may perform a reception operation between uplink DMRS transmissions (e.g., between PUSCH repetitions or PUCCH repetitions), which may have a negative impact on phase continuity. A base station may mitigate this negative impact in the case of scheduled (dynamic) physical downlink shared channel (PDSCH) communications by refraining from scheduling a PDSCH communication during a time period corresponding to an uplink DMRS bundling operation. However, dynamic scheduling may not prevent the UE from performing periodic reception operations during a time period corresponding to an uplink DMRS bundling operation. For example, a UE can start a discontinuous reception (DRX) round trip time (RTT) timer immediately after a first transmission in a bundle. The UE also can start a DRX re-transmission (Re-Tx) timer after the DRX RTT timer has run. For example, a UE can monitor a physical downlink control channel (PDCCH) for possible early termination of its transmission and/or early indication of hybrid automatic repeat request (HARQ) retransmission between repetitions in the DMRS bundle. Performing periodic reception operations like this can cause the UE to lose phase continuity, thereby having a negative impact on the effectiveness and/or support of uplink DMRS bundling operations. As a result, some UEs may not support joint channel estimation, which may result in decreased demodulation performance, increased transmission overhead, and/or other negative impacts on UE and/or network performance.

Some aspects of the techniques and apparatuses described herein may facilitate starting and stopping DRX timers based at least in part on time domain windows associated with DMRS bundling. For example, in some aspects, a UE may transmit at least one PUSCH repetition of a plurality of PUSCH repetitions associated with a joint channel estimation configuration that indicates at least one time domain window for transmission of the plurality of PUSCH repetitions. The UE may activate, after an end of the at least one time domain window, a DRX RTT timer based at least in part on the transmission of the at least one PUSCH repetition. The UE may activate a DRX retransmission timer after an end of the DRX RTT timer. The UE may terminate any DRX timer based on a PUSCH repetition time domain window starting. Thus, in some aspects, a UE may determine that a PUSCH repetition operation (e.g., an uplink DMRS bundling operation) has started and, based at least in part on that determination, may discontinue a reception operation during a time period corresponding to the time domain window. In this way, some aspects described herein may facilitate UE support of joint channel estimation, which may result in increased demodulation performance, decreased transmission overhead, and/or other positive impacts on UE and/or network performance.

FIG. 3 is a diagram illustrating an example 300 associated with DRX timer configurations for joint channel estimation, in accordance with the present disclosure. As shown in FIG. 3, a base station 110 and a UE 120 may communicate with one another.

As shown by reference number 305, the base station 110 may transmit, and the UE 120 may receive, a configuration. The configuration may include, for example, a DRX configuration and/or a joint channel estimation configuration. In some aspects, a joint channel estimation configuration may indicate at least one time domain window for transmission of a plurality of PUSCH repetitions. As used herein, the term “repetition” is used to refer to an initial communication and is also used to refer to a repeated transmission of the initial communication. For example, if the UE 120 is configured to transmit four repetitions, then the UE 120 may transmit an initial transmission and may transmit three repeated transmissions of that initial transmission. Thus, each transmission (regardless of whether the transmission is an initial transmission or a retransmission) is considered a repetition. A repetition may be transmitted in a transmission occasion, which is sometimes referred to as a transmission instance.

In some aspects, a DRX configuration may include an indication that the UE 120 is to activate a DRX RTT timer only after a specified time domain window of a plurality of time domain windows. In some aspects, the DRX configuration may configure any of the behaviors of the UE 120 discussed below in connection with FIGS. 3 and 4.

In some aspects, the base station 110 may transmit the configuration by transmitting a message that includes the configuration. For example, the base station 110 may transmit a radio resource control (RRC) message that includes the configuration. In some aspects, the joint channel estimation configuration may include a portion of a semi-persistent scheduling (SPS) configuration. In some aspects, the joint channel estimation configuration may include a portion of a configuration of a configured grant that indicates a PUSCH repetition. In some aspects, the base station 110 may transmit a downlink control information (DCI) transmission that includes the activity state indication. In some aspects, the DCI transmission may activate an SPS configuration. In some aspects, the DCI transmission may schedule a plurality of repetitions of a PUSCH.

In some aspects, the UE 120 may transmit, and the base station 110 may receive, an indication of a UE capability of the UE. The base station 110 may transmit the configuration based at least in part on the UE capability. In some aspects, for example, the UE capability may include a capability of maintaining a phase continuity for a pair of uplink communications.

As shown by reference number 310, the UE 120 may transmit, and the base station 110 may receive, at least one PUSCH repetition of a plurality of PUSCH repetitions associated with the joint channel estimation configuration. For example, as shown by reference number 315, a number of PUSCH communication resources 320 may be available. The UE 120 may transmit multiple PUSCH repetitions 325 (e.g., to perform an uplink DMRS bundling operation that includes transmitting DMRSs to the base station 110). In some aspects, the UE 120 may transmit the PUSCH repetitions 325 during a configured time domain window 330 corresponding to the uplink DMRS bundling operation. As discussed above, the PUSCH repetitions 325 may be used for joint channel estimation corresponding to an uplink channel. In some aspects, as shown in FIG. 3, a plurality of time domain windows 330 may be configured for PUSCH repetitions.

As shown by reference number 335, the UE 120 may activate, after an end of the time domain window 330, a DRX RTT timer 340. In some aspects, the UE 120 may activate the DRX RTT timer 340 based at least in part on the transmission of the at least one PUSCH repetition 325. In some aspects, the UE 120 may activate the DRX RTT timer 340 in a first symbol to start after the end of the time domain window 330. The UE 120 may activate the DRX RTT timer 340 after an end of a first time domain window 330 of a plurality of time domain windows and/or after a specified time domain window 330 of a plurality of time domain windows (e.g., after a second time domain window 330, a third time domain window 330, and/or a time domain window associated with a channel characteristic or event, among other examples).

As shown by reference number 345, the UE 120 may activate a DRX retransmission (Re-Tx) timer 350 after an expiry of the DRX RTT timer 340. In some aspects, the UE 120 may determine an occurrence of a start of a second time domain window 330 of a plurality of time domain windows and may terminate the DRX RTT timer 340 based at least in part on the determination of the occurrence of the start of the second time domain window 330. In some aspects, the UE 120 may determine an occurrence of an expiry of the DRX RTT timer 340 and activate the DRX retransmission timer 350 based at least in part on the determination of the occurrence of the expiry of the DRX RTT timer 340 and a determination that no time domain window 330 is active. In some aspects, the UE 120 may determine an occurrence of an expiry of the DRX RTT timer 340 and refrain from activating the DRX retransmission timer 350 based at least in part on the determination of the occurrence of the expiry of the DRX RTT timer 340 and a determination that a second time domain window 330 is active. In some aspects, the UE 120 may activate the DRX RTT timer 340 based at least in part on a determination of an occurrence of an end of the second time domain window 330. As shown by reference number 355, the UE 120 may deactivate the DRX retransmission timer 350 based at least in part on a determination of an occurrence of a start of a second time domain window 330.

In some aspects, one or more of the DRX timer behaviors described above (e.g., configurations indicating when to activate and/or deactivate timers and/or rules for activating and/or deactivating timers based on PUSCH repetition time domain windows) may be configured by the network (e.g., via an RRC configuration and/or a dynamic configuration) and/or may be specified in a wireless communication standard.

As indicated above, FIG. 3 is provided as an example. Other examples may differ from what is described with respect to FIG. 3.

FIG. 4 is a diagram illustrating an example process 400 performed, for example, by a UE, in accordance with the present disclosure. Example process 400 is an example where the UE (e.g., UE 120) performs operations associated with DRX timer configurations for joint channel estimation.

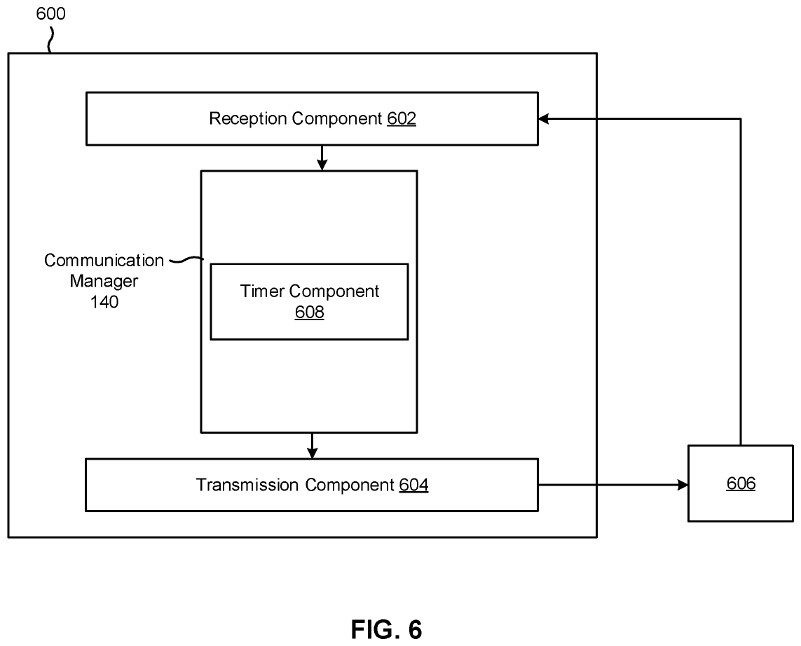

As shown in FIG. 4, in some aspects, process 400 may include transmitting at least one PUSCH repetition of a plurality of PUSCH repetitions associated with a joint channel estimation configuration that indicates at least one time domain window for transmission of the plurality of PUSCH repetitions (block 410). For example, the UE (e.g., using communication manager 140 and/or transmission component 604, depicted in FIG. 6) may transmit at least one PUSCH repetition of a plurality of PUSCH repetitions associated with a joint channel estimation configuration that indicates at least one time domain window for transmission of the plurality of PUSCH repetitions, as described above.

As further shown in FIG. 4, in some aspects, process 400 may include activating, after an end of the at least one time domain window, a DRX RTT timer based at least in part on the transmission of the at least one PUSCH repetition (block 420). For example, the UE (e.g., using communication manager 140 and/or timer component 608, depicted in FIG. 6) may activate, after an end of the at least one time domain window, a DRX RTT timer based at least in part on the transmission of the at least one PUSCH repetition, as described above.

Process 400 may include additional aspects, such as any single aspect or any combination of aspects described below and/or in connection with one or more other processes described elsewhere herein.

In a first aspect, activating the DRX RTT timer comprises activating the DRX RTT timer in a first symbol to start after the end of the at least one time domain window. In a second aspect, alone or in combination with the first aspect, process 400 includes activating a DRX retransmission timer after an expiry of the DRX RTT timer.

In a third aspect, alone or in combination with one or more of the first and second aspects, the at least one time domain window comprises a plurality of time domain windows. In a fourth aspect, alone or in combination with the third aspect, activating the DRX RTT timer comprises activating the DRX RTT timer after an end of a first time domain window of the plurality of time domain windows. In a fifth aspect, alone or in combination with the fourth aspect, process 400 includes determining an occurrence of a start of a second time domain window of the plurality of time domain windows, and terminating the DRX RTT timer based at least in part on the determination of the occurrence of the start of the second time domain window.

In a sixth aspect, alone or in combination with one or more of the fourth through fifth aspects, process 400 includes determining an occurrence of an expiry of the DRX RTT timer, and activating a DRX retransmission timer based at least in part on the determination of the occurrence of the expiry of the DRX RTT timer and a determination that no time domain window is active. In a seventh aspect, alone or in combination with one or more of the fourth through sixth aspects, process 400 includes determining an occurrence of an expiry of the DRX RTT timer, and refraining from activating a DRX retransmission timer based at least in part on the determination of the occurrence of the expiry of the DRX RTT timer and a determination that a second domain window is active.

In an eighth aspect, alone or in combination with the seventh aspect, process 400 includes activating the DRX RTT timer based at least in part on a determination of an occurrence of an end of the second time domain window. In a ninth aspect, alone or in combination with the eighth aspect, process 400 includes deactivating the DRX retransmission timer based at least in part on a determination of an occurrence of a start of a second time domain window.

In a tenth aspect, alone or in combination with one or more of the first through ninth aspects, process 400 includes receiving a DRX configuration including an indication that the UE is to activate the DRX RTT timer only after a specified time domain window of a plurality of time domain windows. In an eleventh aspect, alone or in combination with the tenth aspect, the at least one time domain window comprises the specified time domain window.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a base station, in accordance with the present disclosure. Example process 500 is an example where the base station (e.g., base station 110) performs operations associated with DRX timer configurations for joint channel estimation.

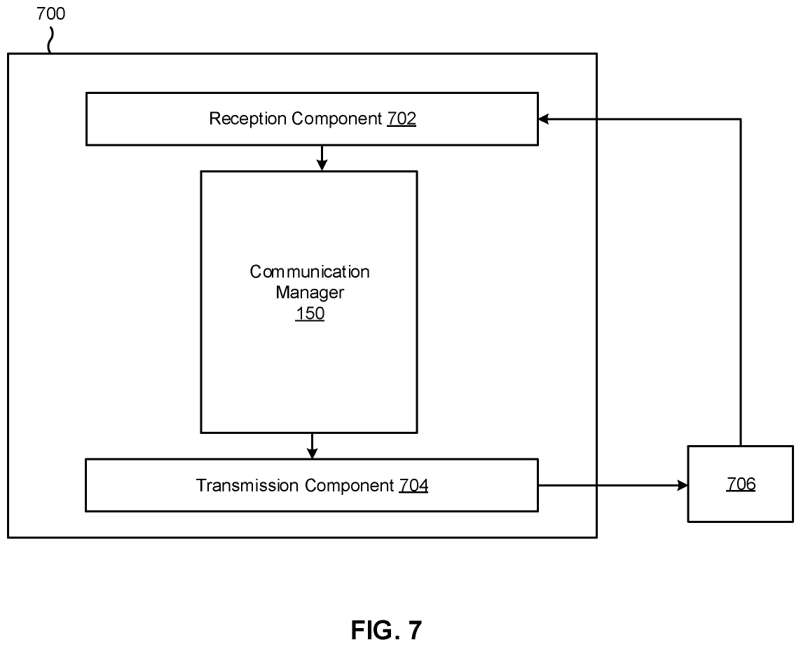

As shown in FIG. 5, in some aspects, process 500 may include transmitting a joint channel estimation configuration that indicates at least one time domain window for transmission of a plurality of PUSCH repetitions (block 510). For example, the base station (e.g., using communication manager 150 and/or transmission component 704, depicted in FIG. 7) may transmit a joint channel estimation configuration that indicates at least one time domain window for transmission of a plurality of PUSCH repetitions, as described above.

As further shown in FIG. 5, in some aspects, process 500 may include transmitting a discontinuous reception configuration that indicates that a UE is to activate a DRX RTT timer based at least in part on an occurrence of an end of the at least one time domain window (block 520). For example, the base station (e.g., using communication manager 150 and/or transmission component 704, depicted in FIG. 7) may transmit a discontinuous reception configuration that indicates that a UE is to activate a DRX RTT timer based at least in part on an occurrence of an end of the at least one time domain window, as described above.

Process 500 may include additional aspects, such as any single aspect or any combination of aspects described below and/or in connection with one or more other processes described elsewhere herein.

In a first aspect, the DRX configuration indicates that the UE is to activate the discontinuous reception RTT timer in a first symbol to start after the end of the at least one time domain window. In a second aspect, alone or in combination with the first aspect, the DRX configuration indicates that the UE is to activate a DRX retransmission timer after an expiry of the DRX RTT timer. In a third aspect, alone or in combination with one or more of the first and second aspects, the at least one time domain window comprises a plurality of time domain windows. In a fourth aspect, alone or in combination with the third aspect, the DRX configuration indicates that the UE is to activate the DRX RTT timer after an end of a first time domain window of the plurality of time domain windows. In a fifth aspect, alone or in combination with the fourth aspect, the DRX configuration indicates that the UE is to terminate the DRX RTT timer based at least in part on a determination of the occurrence of the start of a second time domain window.

In a sixth aspect, alone or in combination with one or more of the fourth through fifth aspects, the DRX configuration indicates that the UE is to activate a DRX retransmission timer based at least in part on a determination of the occurrence of an expiry of the DRX RTT timer and a determination that no time domain window is active. In a seventh aspect, alone or in combination with one or more of the fourth through sixth aspects, the DRX configuration indicates that the UE is to refrain from activating a DRX retransmission timer based at least in part on a determination of the occurrence of an expiry of the DRX RTT timer and a determination that a second time domain window is active. In an eighth aspect, alone or in combination with the seventh aspect, the DRX configuration indicates that the UE is to activate the DRX RTT timer based at least in part on a determination of an occurrence of an end of the second time domain window. In a ninth aspect, alone or in combination with the eighth aspect, the DRX configuration indicates that the UE is to deactivate the DRX retransmission timer based at least in part on a determination of an occurrence of a start of a second time domain window.

In a tenth aspect, alone or in combination with one or more of the first through ninth aspects, the DRX configuration comprises an indication that the UE is to activate the DRX RTT timer only after a specified time domain window of a plurality of time domain windows. In an eleventh aspect, alone or in combination with one or more of the first through tenth aspects, the at least one time domain window comprises the specified time domain window.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include a timer component 608.

In some aspects, the apparatus 600 may be configured to perform one or more operations described herein in connection with FIG. 3. Additionally, or alternatively, the apparatus 600 may be configured to perform one or more processes described herein, such as process 400 of FIG. 4. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The transmission component 604 may transmit at least one PUSCH repetition of a plurality of PUSCH repetitions associated with a joint channel estimation configuration that indicates at least one time domain window for transmission of the plurality of PUSCH repetitions. The timer component 608 may activate, after an end of the at least one time domain window, a DRX RTT timer based at least in part on the transmission of the at least one PUSCH repetition. In some aspects, the timer component 608 may include one or more antennas, a modem, a modulator, a transmit MIMO processor, a transmit processor, a controller/processor, a memory, or a combination thereof, of the UE described in connection with FIG. 2. In some aspects, the timer component 608 may include the reception component 602 and/or the transmission component 604.

The timer component 608 may activate a DRX retransmission timer after an expiry of the DRX RTT timer. The communication manager 140 may determine an occurrence of a start of a second time domain window of the plurality of time domain windows. In some aspects, the communication manager 140 may include one or more antennas, a modem, a modulator, a transmit MIMO processor, a transmit processor, a controller/processor, a memory, or a combination thereof, of the UE described in connection with FIG. 2. In some aspects, the communication manager 140 may include the reception component 602 and/or the transmission component 604.

The timer component 608 may terminate the DRX RTT timer based at least in part on the determination of the occurrence of the start of the second time domain window. The timer component 608 may determine an occurrence of an expiry of the DRX RTT timer.

The timer component 608 may activate a DRX retransmission timer based at least in part on the determination of the occurrence of the expiry of the DRX RTT timer and a determination that no time domain window is active. The timer component 608 may determine an occurrence of an expiry of the DRX RTT timer.

The communication component 140 may refrain from activating a DRX retransmission timer based at least in part on the determination of the occurrence of the expiry of the DRX RTT timer and a determination that a time domain window is active. The timer component 608 may activate the discontinuous reception RTT timer based at least in part on a determination of an occurrence of an end of the first time domain window. The timer component 608 may deactivate the DRX retransmission timer based at least in part on a determination of an occurrence of a start of a second time domain window. The reception component 602 may receive a DRX configuration including an indication that the UE is to activate the DRX RTT timer only after a specified time domain window of a plurality of time domain windows.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a base station, or a base station may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 150.

In some aspects, the apparatus 700 may be configured to perform one or more operations described herein in connection with FIG. 3. Additionally, or alternatively, the apparatus 700 may be configured to perform one or more processes described herein, such as process 500 of FIG. 5. In some aspects, the apparatus 700 and/or one or more components shown in FIG. 7 may include one or more components of the base station described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the base station described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the base station described in connection with FIG. 2. In some aspects, the transmission component 704 may be co-located with the reception component 702 in a transceiver.

The communication manager 150 and/or the transmission component 704 may transmit a joint channel estimation configuration that indicates at least one time domain window for transmission of a plurality of PUSCH repetitions. The transmission component 704 may transmit a DRX configuration that indicates that a UE is to activate a DRX RTT timer based at least in part on an occurrence of an end of the at least one time domain window. In some aspects, the communication manager 150 may include one or more antennas, a modem, a modulator, a transmit MIMO processor, a transmit processor, a controller/processor, a memory, or a combination thereof, of the base station described in connection with FIG. 2. In some aspects, the communication manager 150 may include the reception component 702 and/or the transmission component 704.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: transmitting at least one physical uplink shared channel (PUSCH) repetition of a plurality of PUSCH repetitions associated with a joint channel estimation configuration that indicates at least one time domain window for transmission of the plurality of PUSCH repetitions; and activating, after an end of the at least one time domain window, a discontinuous reception round trip time (RTT) timer based at least in part on the transmission of the at least one PUSCH repetition.

Aspect 2: The method of Aspect 1, wherein activating the discontinuous reception RTT timer comprises activating the discontinuous reception RTT timer in a first symbol to start after the end of the at least one time domain window.

Aspect 3: The method of either of Aspects 1 or 2, further comprising activating a discontinuous reception retransmission timer after an expiry of the discontinuous reception RTT timer.

Aspect 4: The method of any of Aspects 1-3, wherein the at least one time domain window comprises a plurality of time domain windows.

Aspect 5: The method of Aspect 4, wherein activating the discontinuous reception RTT timer comprises activating the discontinuous reception RTT timer after an end of a first time domain window of the plurality of time domain windows.

Aspect 6: The method of Aspect 5, further comprising: determining an occurrence of a start of a second time domain window of the plurality of time domain windows; and terminating the discontinuous reception RTT timer based at least in part on the determination of the occurrence of the start of the second time domain window.

Aspect 7: The method of Aspect 5, further comprising: determining an occurrence of an expiry of the discontinuous reception RTT timer; and activating a discontinuous reception retransmission timer based at least in part on the determination of the occurrence of the expiry of the discontinuous reception RTT timer and a determination that no time domain window is active.

Aspect 8: The method of Aspect 5, further comprising: determining an occurrence of an expiry of the discontinuous reception RTT timer; and refraining from activating a discontinuous reception retransmission timer based at least in part on the determination of the occurrence of the expiry of the discontinuous reception RTT timer and a determination that a second time domain window is active.

Aspect 9: The method of Aspect 8, further comprising activating the discontinuous reception RTT timer based at least in part on a determination of an occurrence of an end of the second time domain window.

Aspect 10: The method of Aspect 9, further comprising deactivating the discontinuous reception retransmission timer based at least in part on a determination of an occurrence of a start of a second time domain window.

Aspect 11: The method of any of Aspects 1-10, further comprising receiving a discontinuous reception configuration including an indication that the UE is to activate the discontinuous reception RTT timer only after a specified time domain window of a plurality of time domain windows.

Aspect 12: The method of Aspect 11, wherein the at least one time domain window comprises the specified time domain window.

Aspect 13: A method of wireless communication performed by a base station, comprising: transmitting a joint channel estimation configuration that indicates at least one time domain window for transmission of a plurality of physical uplink shared channel (PUSCH) repetitions; and transmitting a discontinuous reception configuration that indicates that a user equipment (UE) is to activate a discontinuous reception round trip time (RTT) timer based at least in part on an occurrence of an end of the at least one time domain window.

Aspect 14: The method of Aspect 13, wherein the discontinuous reception configuration indicates that the UE is to activate the discontinuous reception RTT timer in a first symbol to start after the end of the at least one time domain window.

Aspect 15: The method of either of Aspects 13 or 14, wherein the discontinuous reception configuration indicates that the UE is to activate a discontinuous reception retransmission timer after an expiry of the discontinuous reception RTT timer.

Aspect 16: The method of any of Aspects 13-15, wherein the at least one time domain window comprises a plurality of time domain windows.

Aspect 17: The method of Aspect 16, wherein the discontinuous reception configuration indicates that the UE is to activate the discontinuous reception RTT timer after an end of a first time domain window of the plurality of time domain windows.

Aspect 18: The method of Aspect 17, wherein the discontinuous reception configuration indicates that the UE is to terminate the discontinuous reception RTT timer based at least in part on a determination of the occurrence of a start of a second time domain window.

Aspect 19: The method of either of Aspects 17 or 18, wherein the discontinuous reception configuration indicates that the UE is to activate a discontinuous reception retransmission timer based at least in part on a determination of the occurrence of an expiry of the discontinuous reception RTT timer and a determination that no time domain window is active.

Aspect 20: The method of any of Aspects 17-19, wherein the discontinuous reception configuration indicates that the UE is to refrain from activating a discontinuous reception retransmission timer based at least in part on a determination of the occurrence of an expiry of the discontinuous reception RTT timer and a determination that a second time domain window is active.

Aspect 21: The method of Aspect 20, wherein the discontinuous reception configuration indicates that the UE is to activate the discontinuous reception RTT timer based at least in part on a determination of an occurrence of an end of the second time domain window.

Aspect 22: The method of Aspect 21, wherein the discontinuous reception configuration indicates that the UE is to deactivate the discontinuous reception retransmission timer based at least in part on a determination of an occurrence of a start of a second time domain window.

Aspect 23: The method of any of Aspects 13-22, wherein the discontinuous reception configuration comprises an indication that the UE is to activate the discontinuous reception RTT timer only after a specified time domain window of a plurality of time domain windows.

Aspect 24: The method of Aspect 23, wherein the at least one time domain window comprises the specified time domain window.

Aspect 25: An apparatus for wireless communication at a device, comprising a processor; memory coupled with the processor; and instructions stored in the memory and executable by the processor to cause the apparatus to perform the method of one or more of Aspects 1-12.

Aspect 26: A device for wireless communication, comprising a memory and one or more processors coupled to the memory, the one or more processors configured to perform the method of one or more of Aspects 1-12.

Aspect 27: An apparatus for wireless communication, comprising at least one means for performing the method of one or more of Aspects 1-12.

Aspect 28: A non-transitory computer-readable medium storing code for wireless communication, the code comprising instructions executable by a processor to perform the method of one or more of Aspects 1-12.

Aspect 29: A non-transitory computer-readable medium storing a set of instructions for wireless communication, the set of instructions comprising one or more instructions that, when executed by one or more processors of a device, cause the device to perform the method of one or more of Aspects 1-12.

Aspect 30: An apparatus for wireless communication at a device, comprising a processor; memory coupled with the processor; and instructions stored in the memory and executable by the processor to cause the apparatus to perform the method of one or more of Aspects 13-24.

Aspect 31: A device for wireless communication, comprising a memory and one or more processors coupled to the memory, the one or more processors configured to perform the method of one or more of Aspects 13-24.

Aspect 32: An apparatus for wireless communication, comprising at least one means for performing the method of one or more of Aspects 13-24.

Aspect 33: A non-transitory computer-readable medium storing code for wireless communication, the code comprising instructions executable by a processor to perform the method of one or more of Aspects 13-24.

Aspect 34: A non-transitory computer-readable medium storing a set of instructions for wireless communication, the set of instructions comprising one or more instructions that, when executed by one or more processors of a device, cause the device to perform the method of one or more of Aspects 13-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit at least one physical uplink shared channel (PUSCH) repetition of a plurality of PUSCH repetitions associated with a joint channel estimation configuration that indicates at least one time domain window for transmission of the plurality of PUSCH repetitions; and
activate, after an end of the at least one time domain window, a discontinuous reception round trip time (RTT) timer based at least in part on the transmission of the at least one PUSCH repetition.

2. The apparatus of claim 1, wherein the one or more processors, to activate the discontinuous reception RTT timer, are configured to activate the discontinuous reception RTT timer in a first symbol to start after the end of the at least one time domain window.

3. The apparatus of claim 1, wherein the one or more processors are further configured to activate a discontinuous reception retransmission timer after an expiry of the discontinuous reception RTT timer.

4. The apparatus of claim 1, wherein the at least one time domain window comprises a plurality of time domain windows.

5. The apparatus of claim 4, wherein the one or more processors, to activate the discontinuous reception RTT timer, are configured to activate the discontinuous reception RTT timer after an end of a first time domain window of the plurality of time domain windows.

6. The apparatus of claim 5, wherein the one or more processors are further configured to:
determine an occurrence of a start of a second time domain window of the plurality of time domain windows; and
terminate the discontinuous reception RTT timer based at least in part on the determination of the occurrence of the start of the second time domain window.

7. The apparatus of claim 5, wherein the one or more processors are further configured to:
determine an occurrence of an expiry of the discontinuous reception RTT timer; and
activate a discontinuous reception retransmission timer based at least in part on the determination of the occurrence of the expiry of the discontinuous reception RTT timer and a determination that no time domain window is active.

8. The apparatus of claim 5, wherein the one or more processors are further configured to:
determine an occurrence of an expiry of the discontinuous reception RTT timer; and
refrain from activating a discontinuous reception retransmission timer based at least in part on the determination of the occurrence of the expiry of the discontinuous reception RTT timer and a determination that a second time domain window is active.

9. The apparatus of claim 8, wherein the one or more processors are further configured to activate the discontinuous reception RTT timer based at least in part on a determination of an occurrence of an end of the second time domain window.

10. The apparatus of claim 9, wherein the one or more processors are further configured to deactivate the discontinuous reception retransmission timer based at least in part on a determination of an occurrence of a start of a second time domain window.

11. The apparatus of claim 1, wherein the one or more processors are further configured to receive a discontinuous reception configuration including an indication that the UE is to activate the discontinuous reception RTT timer only after a specified time domain window of a plurality of time domain windows.

12. The apparatus of claim 11, wherein the at least one time domain window comprises the specified time domain window.

13. An apparatus for wireless communication at a base station, comprising:
a memory; and
one or more processors, coupled to the memory, configured to:
transmit a joint channel estimation configuration that indicates at least one time domain window for transmission of a plurality of physical uplink shared channel (PUSCH) repetitions; and
transmit a discontinuous reception configuration that indicates that a user equipment (UE) is to activate a discontinuous reception round trip time (RTT) timer based at least in part on an occurrence of an end of the at least one time domain window.

14. The apparatus of claim 13, wherein the one or more processors are further configured to activate the discontinuous reception RTT timer in a first symbol to start after the end of the at least one time domain window.

15. The apparatus of claim 13, wherein the one or more processors are further configured to activate a discontinuous reception retransmission timer after an expiry of the discontinuous reception RTT timer.

16. The apparatus of claim 13, wherein the at least one time domain window comprises a plurality of time domain windows.

17. The apparatus of claim 16, wherein the one or more processors are further configured to activate the discontinuous reception RTT timer after an end of a first time domain window of the plurality of time domain windows.

18. The apparatus of claim 17, wherein the one or more processors are further configured to terminate the discontinuous reception RTT timer based at least in part on a determination of the occurrence of a start of a second time domain window.

19. The apparatus of claim 17, wherein the one or more processors are further configured to activate a discontinuous reception retransmission timer based at least in part on a determination of the occurrence of an expiry of the discontinuous reception RTT timer and a determination that no time domain window is active.

20. The apparatus of claim 17, wherein the one or more processors are further configured to refrain from activating a discontinuous reception retransmission timer based at least in part on a determination of the occurrence of an expiry of the discontinuous reception RTT timer and a determination that a second time domain window is active.

21. The apparatus of claim 20, wherein the one or more processors are further configured to activate the discontinuous reception RTT timer based at least in part on a determination of an occurrence of an end of the second time domain window.

22. The apparatus of claim 21, wherein the one or more processors are further configured to deactivate the discontinuous reception retransmission timer based at least in part on a determination of an occurrence of a start of a second time domain window.

23. The apparatus of claim 13, wherein the discontinuous reception configuration comprises an indication that the UE is to activate the discontinuous reception RTT timer only after a specified time domain window of a plurality of time domain windows.

24. The apparatus of claim 23, wherein the at least one time domain window comprises the specified time domain window.

25. A method of wireless communication performed by a user equipment (UE), comprising:
transmitting at least one physical uplink shared channel (PUSCH) repetition of a plurality of PUSCH repetitions associated with a joint channel estimation configuration that indicates at least one time domain window for transmission of the plurality of PUSCH repetitions; and
activating, after an end of the at least one time domain window, a discontinuous reception round trip time (RTT) timer based at least in part on the transmission of the at least one PUSCH repetition.

26. The method of claim 25, further comprising activating a discontinuous reception retransmission timer after an expiry of the discontinuous reception RTT timer.

27. The method of claim 25, further comprising receiving a discontinuous reception configuration including an indication that the UE is to activate the discontinuous reception RTT timer only after a specified time domain window of a plurality of time domain windows.

28. A method of wireless communication performed by a base station, comprising:
transmitting a joint channel estimation configuration that indicates at least one time domain window for transmission of a plurality of physical uplink shared channel (PUSCH) repetitions; and
transmitting a discontinuous reception configuration that indicates that a user equipment (UE) is to activate a discontinuous reception round trip time (RTT) timer based at least in part on an occurrence of an end of the at least one time domain window.

29. The method of claim 28, wherein the discontinuous reception configuration indicates that the UE is to activate a discontinuous reception retransmission timer after an expiry of the discontinuous reception RTT timer.

30. The method of claim 28, wherein the discontinuous reception configuration comprises an indication that the UE is to activate the discontinuous reception RTT timer only after a specified time domain window of a plurality of time domain windows.
